(19) United States
(12) Patent Application Publication
(10) Pub. No.: US 2011/0283613 A1
(43) Pub. Date: Nov. 24, 2011

(54) HANGING PLANTING CONTAINER FOR EXTENDED WATERING OF PLANTS

(76) Inventor: Darrell K. Downey, Canton, GA (US)

(21) Appl. No.: 12/785,463

(22) Filed: May 23, 2010

(51) Int. Cl. A01G 9/02

(52) U.S. Cl. 47/65.7; 47/67

(57) ABSTRACT

A hanging planter for watering and growing transplanted plants either upwardly or downwardly includes lay-flat flexible tubing which is hung or supported in an upright position, the lay-flat flexible tubing serving as a container for the plants. A lay-flat flexible tube is sealed so as to create an upper watertight chamber above separated from a lower well-drained soil chamber, into which a plant is planted or transplanted. Water flow from the upper chamber to the lower chamber is controlled by a water flow restriction element.

### FIELD OF THE INVENTION

The invention generally relates to planting containers for growing plants, and particularly to hanging planting containers.

### BACKGROUND OF THE INVENTION

Gardeners spend millions of dollars each year on ornamental plants and vegetables which are transplanted into a variety of containers which both rest on the ground and hang from hooks or poles. Most often, the soil mixture that surrounds the plant roots in the container is very porous and dries quickly through plant use and evaporation. Because of this, the plants require watering on at least a daily basis. Typically, the gardener adds a copious amount of water to the top of the container or hanging basket each day. As the water seeps down through the soil mixture in the container, the soil particles are wetted and the excess water drains from the container through holes in its bottom. Drainage is important because most plants require a certain amount of oxygen within the small pore spaces between the soil in order to survive.

The daily watering of plants in growing containers is both time consuming and a significant commitment for the gardener. If she needs to leave town for just one weekend, she must either find someone to water her plants or return home to find dead or damaged plants. If she leaves for a week long vacation, many of her plants will most assuredly die if left unattended.

A number of devices have been invented that enable gardeners to extend the watering cycle, or the time between watering events. For example, U.S. Pat. Nos. 6,715,233 B2 and 6,691,460 B1 provide for rigid vessels which store a limited amount of water within the body of the container for later delivery to the soil in the planting container. These designs are both expensive and restrictive in their application.

U.S. Pat. Nos. 7,082,715 B2, 7,596,905 B2, 6,418,663 B1, 6,684,563 B2, and 6,601,339 B1 all provide for rigid vessels which hold a limited amount of water above an independent planting container for later release to the soil.

U.S. Pat. Nos. 6,643,978 B2, 6,418,664 B1, and 6,782,659 B2 all provide for rigid vessels which store limited amounts of water below the soil in the container and provide means to draw it upwards to the plant roots by capillary action of a wicking element.

U.S. Pat. Nos. 6,845,588 B2, 6,843,022 B1, and 7,219,468 B1 all provide for watering through connection to a pressurized water source, requiring piping systems which may or may not be feasible in many applications.

U.S. Pat. Nos. 6,874,278 B2 and 7,171,782 B2 provide for planting hanging plants within a soil filled chamber constructed of flexible tubing. These inventions require rigid end pieces and do not provide a solution for the problem of extended watering.

U.S. Pat. No. 7,082,716 B2 provides for a large reservoir of water that is created from flexible tubing. No soil chamber is underneath this device. Furthermore, no provisions are made for hanging this device as its primary objective is watering newly planted trees.

### SUMMARY OF THE INVENTION

This invention includes a lay-flat flexible tube that can be hung or supported from a hook or pole, and that can be filled with both water and soil in separate chambers of the lay-flat flexible tube so as to create an inexpensive self-watering growing container. Soil is added to the lower chamber of the lay-flat flexible tube, into which a plant or seed is transplanted. Water is added to the upper chamber of the lay-flat flexible tube and is slowly released to the roots by means of a precisely controlled flow restriction device.

The planting container for extended watering of this invention includes a lay-flat flexible tube which is sealed at both ends, and is also sealed perpendicularly so as to form two separate chambers. A hole is cut into the flexible tube just below the upper seal and at the top of the upper chamber. This hole is used for both filling the upper chamber with water and for hanging the entire device from a hook. A slit is cut through both plies of the flexible tube just below and perpendicular to the seal that separates the two chambers. By separating the two walls of the lay-flat flexible tube, soil may be added to the lower chamber until it is filled. The weight of the soil separates the two walls of the flexible tube below the slit so that the surface of the soil is readily exposed.

A seed or plant is transplanted into the soil, on either or both sides of the device. A conventional drip emitter is inserted into the lower portion of the water filled upper chamber, so that it receives, at its inlet, the full head pressure of the water in the chamber above it. As water flows through the drip emitter, its pressure is reduced to ambient by friction loss through the internal passageways, and water discharges at a slow and consistent drip, which falls directly on to the surface of the soil in the soil filled chamber below it. A small hole is created in the lower portion of the soil-filled lower chamber to allow excess water to drain from the soil. Because of the flexibility of the device, large quantities of water may be retained and administered over extended periods of time, from one day to one week.

In one general aspect, the invention is a hanging planter for containing and watering vegetation. The hanging planter includes: a lay-flat flexible tube having two walls, the two walls being sealed by a top seal, a middle seal, and a bottom seal so as to form an upper chamber and a lower chamber; and a hanging element disposed near a top portion of the upper chamber capable of being used to hang the lay-flat flexible tube so that the upper chamber is oriented directly above the lower chamber, the upper chamber having an opening so as to facilitate filling the upper chamber with water; the lower chamber having an opening so as to facilitate filling the lower chamber with growing media; the upper chamber having a flow regulator capable of regulating a flow of water from the upper chamber to the lower chamber; the lower chamber having a drain capable of draining excess water from the flow of water upon the growing media in the lower chamber.

In a preferred embodiment, the lay-flat flexible tube is made from one of: plastic, low density polyethylene, flexible PVC.

In another preferred embodiment, the upper chamber and the lower chamber are equal in volume. In an alternate preferred embodiment, the upper chamber and the lower chamber are not equal in volume.

In a preferred embodiment, the hanging element is a hole cut near the top seal.

In a preferred embodiment, the hanging element is a rigid member attached near the top seal.

In a preferred embodiment, the opening in the lower chamber is a horizontal slit cut through at least one wall of the flexible tube near a top portion of the lower chamber.

In a preferred embodiment, the growing medium is soil.

In a preferred embodiment, the bottom seal is a recloseable closure. In a further preferred embodiment, the recloseable closure is mating hook and loop.

In an alternate further preferred embodiment, the recloseable closure is double sided tape with acrylic based adhesive.

In a preferred embodiment, the upper chamber is filled through the hole cut near the top seal.

In another preferred embodiment, the upper chamber is filled through a recloseable opening therein.

In a preferred embodiment, a flow of water from the upper chamber into the lower chamber can be regulated by at least one drip emitter placed at least near the bottom of the uppermost chamber.

In a preferred embodiment, excess water is drained from the lower chamber by a small hole at least near a bottom of the lower chamber. In a further preferred embodiment, excess water is drained by seeping through the hook and loop reclosure.

In a preferred embodiment, the opening in the lower chamber for filling the lower chamber with growing media is large enough to also allow planting in the growing media. In a further preferred embodiment, a pre-started plant can be inserted into the bottom of the lower chamber through the opened recloseable opening, and the reclosable opening can be reclosed so as to secure a root-ball therein.

In a preferred embodiment, at least one vertical seal is formed longitudinally between the walls of the upper chamber so as strengthen the upper chamber, while also allowing all water in the upper chamber to be flow through the flow regulator.

In a preferred embodiment, the bottom of the lower chamber is adapted to rest on the ground so as to reduce stress on the hanging element.

### BRIEF DESCRIPTION OF THE DRAWINGS

The invention will be more fully understood by reference to the detailed description, in conjunction with the following figures, wherein:

FIG. 1 is a front view of an embodiment of a planting container according to this invention;

FIG. 2 is a side view of the planting container of FIG. 1;

FIG. 3 is a front view of a planting container that is intended for growing plants that are inverted (roots above stem);

FIG. 4 is a front view of the planting container of FIG. 3 with the bottom securing flaps secured;

FIG. 5 is a front view of a planting container for growing inverted plants which has a diagonal flap bottom closing configuration;

FIG. 6 is a front view of a planting container for growing inverted plants which has a twist and tie bottom closing configuration;

FIG. 7 is a front view showing various means that may be employed to reduce evaporative losses;

FIG. 8 is a frontal side view showing a different means of hanging the device;

FIG. 9 is a front view showing multiple drip emitters may be employed;

FIG. 10 is a front view showing that a gusseted bag design may be employed;

FIG. 11 is a front view showing that vertical seals may be employed to restrict the outward swell of the walls of the upper water holding chamber;

FIG. 12 is a side view of FIG. 11 illustrating an effect of the vertical seals;

FIG. 13 is a front view showing a flexible tube oriented ninety degrees from a preferred embodiment;

FIG. 14 is a front view of FIG. 13 showing a means of growing an inverted plant;

FIG. 15 is a front view showing the device may be constructed in a variety of aesthetically pleasing shapes; and

FIG. 16 is a front view showing and embodiment of the device elongated for greater water holding capacity, with additional weight being transferred to the ground.

### DETAILED DESCRIPTION OF THE DRAWINGS

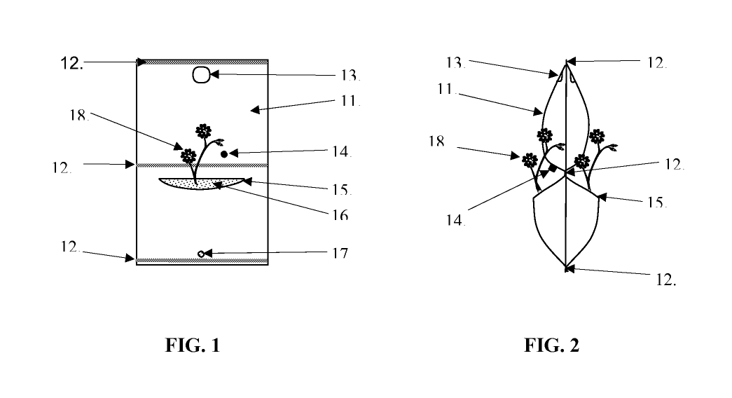

Turning now to the drawings in greater detail and considering first FIGS. 1 and 2, there is shown a certain presently preferred embodiment which is constructed of a lay-flat flexible tube 11. Flexible tube 11 is preferably made of low density polyethylene having a gage of 8 to 12 mils. Other fabrics and polymeric materials, having varying wall thicknesses may be utilized, provided they do not allow water to pass through their surface and furthermore provided that their strength is adequate to support the weight of the combined water, soil and plant material. Three seals 12 are formed in flexible tube 11, the first occurring at the very top of the tube 11, the second occurring near or about the middle of the tube 11, and the third occurring near the bottom of the tube 11. The seals 12, are presently preferred to be accomplished by applying heat and pressure but other means of joining flexible sheeting may be employed including gluing, sewing and the like, provided such techniques are watertight and further provided they are strong enough to withstand the separation forces which result from the combined weight of the water, soil and plant material. A hole 13, is cut from the flexible tube 11, just under the uppermost seal 12. The center of hole 13, coincides with the vertical longitudinal axis of tube 11 so that the device will hang in a plumb position when suspended by a hook that is placed within hole 13. The presently preferred diameter of hole 3 is 1½ to 3 inches but other diameters may be employed provided they are large enough to enable the insertion of a water hose nozzle or other filling device. A horizontal slit 15 is cut through both walls of the flexible tube 11 just under the center seal 12. As the two walls of the tube 11 are separated and filled with soil 16, the outward pressure of the soil 16 creates an exposed surface of soil 16 which may be better understood by reviewing FIG. 2. In the presently preferred embodiment, the length of the horizontal slit 15, is approximately ¾ of the overall width of tube 11 but other lengths may be employed to achieve varying soil volumes and appearances provided strength of tube 11 material is adequate to support the weight the wetted soil and plant material. A drainage hole 17 is cut into the flexible tube 11 just above the lowermost seal 12 to enable draining excess water from the soil bearing chamber. A drip emitter 14, is inserted into the wall of flexible tube 11 just above the middle seal 12. In the presently preferred embodiment, the drip emitter 14 is a standard and commercially available non pressure compensating drip emitter, having a barbed inlet and rated for delivering 1 gallon per hour of water flow rate at an inlet pressure of 15 pounds per square inch but other types of flow regulation devices may be employed including non pressure compensating drip emitters rated up to 4 gallons per hour, and pressure compensating drip emitters of various flow rate designations provided the pressure compensation device is operable at inlet pressures between 0 and 1 pound per square inch. Plant material 18, is transplanted into soil 16 on either or both sides of device as shown in FIG. 2.

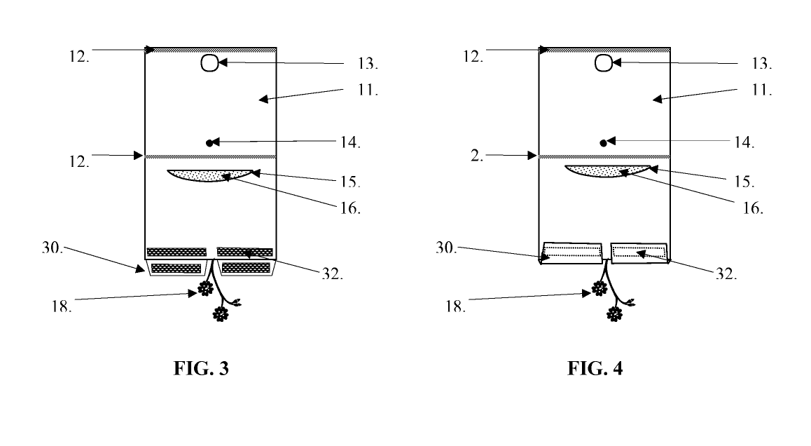

Turning our attention to FIGS. 3 and 4, the lowermost seal 12 is replaced with two end flaps 30. Mating Hook and Loop fasteners 32, are attached to the lowermost part of tube 11 and the outermost part of flaps 30. With the flaps 30 open, the root ball of a prestarted plant 18 is placed inside the flexible tube 11, a process made easier by laying the unfilled device flat upon the ground. Flaps 30 are folded over to engage hook and loop fastener 32 as shown in FIG. 4 and securing root ball of plant 18 inside tube 11 while allowing stem and foliage of plant 18 to remain outside tube 11. Device is then hung vertically from a hook inserted into hole 13. Soil 16 is added through horizontal slit 15 and cooperates with the root ball of plant 18. Water is added to tube 11 through hole 13 until the uppermost chamber is full. Water is slowly released through drip emitter 14 to maintain the watering status of plant 18 for an extended period of time. As uppermost reservoir in tube 11 exhausts its supply of water, it is refilled via hole 13.

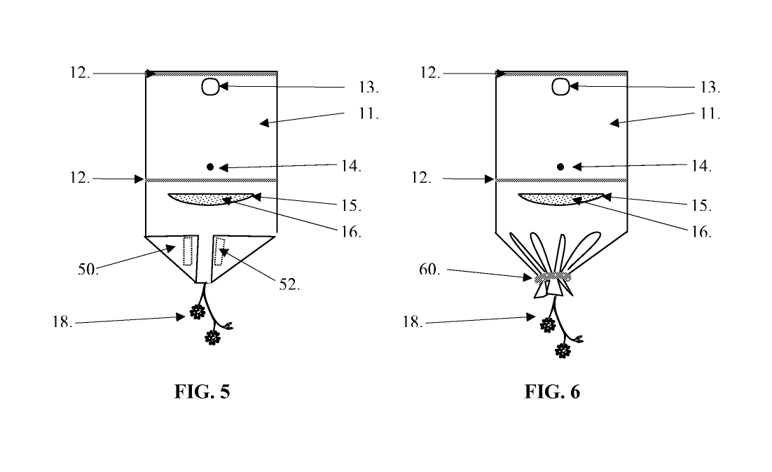

Turning our attention to FIG. 5, the end flaps 50 are folded diagonally across tube 11 and joined by hook and loop fastener 52.

In FIG. 6, in an alternative to the embodiment of FIG. 5, the unsealed lowermost end of flexible tube 11 is bunched together around the stem of plant 18 and secured with string 60.

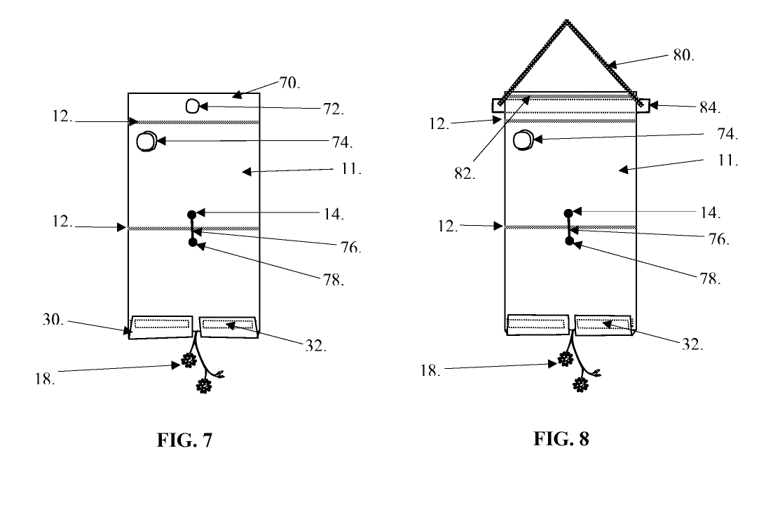

In FIG. 7, means are illustrated for reducing evaporative losses from the device and preventing undesired contaminates from entering the water reservoir. Tube 11 is extended a few inches above the uppermost seal 12 to form a hanging flap 70. In the presently preferred embodiment, water is entered into the uppermost chamber of tube 11 through a reclosable cap 74 which is sealed into one wall of tube 11 but other reclosable means of sealing may be employed, including zip lock closures. A small tube 76 is attached to the discharge end of drip emitter 14 and routed inside soil bearing and lowermost chamber of tube 11 through a small opening 78 in tube 11. In this embodiment, which is not presently preferred, the prescribed amount of soil must be first added into tube 11 through the opened end flaps 30, which is enabled by first inverting the unfilled device. After soil is added, the root ball of plant 18 is inserted into the tube 11 and secured in place by closing end flaps 30 with hook and loop fasteners 32. When inversion of tube 11 is reversed by hanging tube 11 from hole 72, soil falls by gravity and cooperates with root ball of plant 18.

In FIG. 8, a rigid member 84 is utilized to support and hang device when secured with chain 80. Chain 80 may be replaced with string, rope, wire or other flexible or rigid material, provided such material is strong enough to withstand the downward force of the combined weight of water, soil, plant material and device.

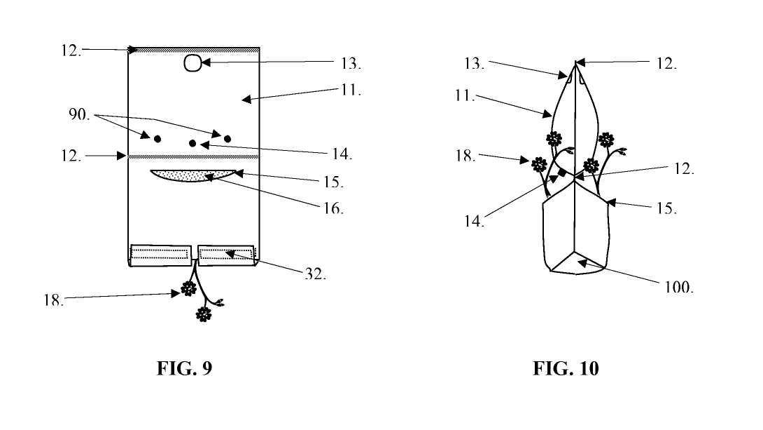

In FIG. 9 multiple drip emitters 90 are shown as may be necessary to accomplished the prescribed watering rate or dispersion.

In FIG. 10 flexible tube 11 may be constructed so as to have a gusseted bottom 100 for greater soil holding capacity and appearance.

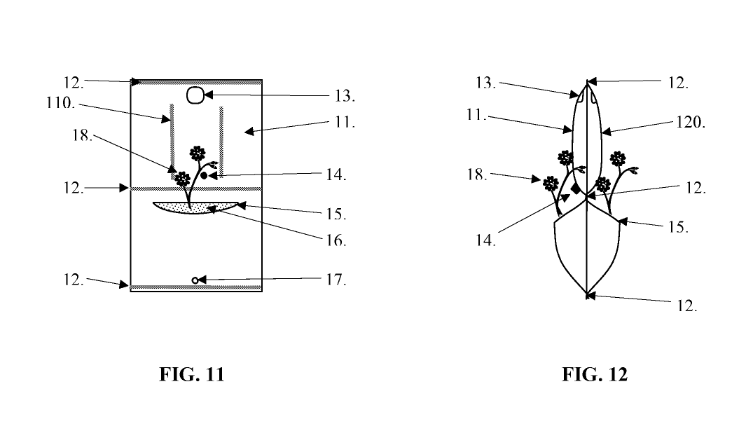

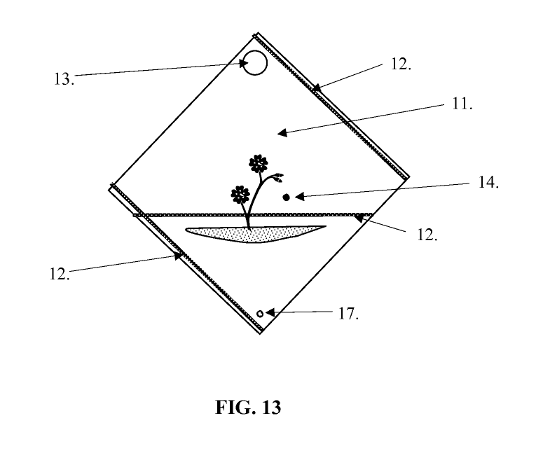

In FIGS. 11 and 12, vertical seals 110 may be added to restrict the outward separation or bulge of the uppermost water chamber 120 in order to enable more light to reach plant 18.

In FIG. 13, the longitudinal axis of flexible tube 11 is rotated 90 degrees to create a more aesthetically appearing shape. Seals 12 are reoriented accordingly.

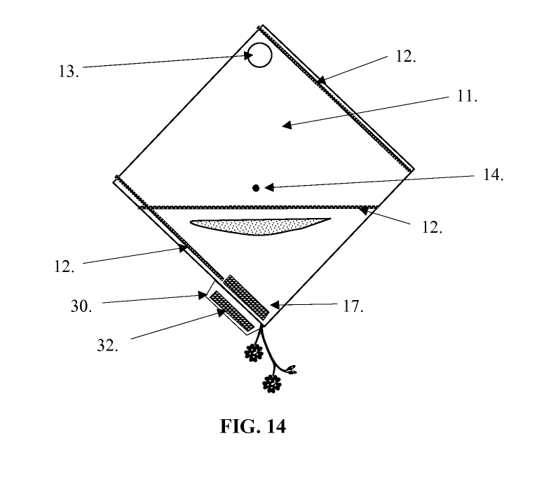

In FIG. 14, end flap 142 is created to enable growing plant material 18 in an inverted or upside down manner.

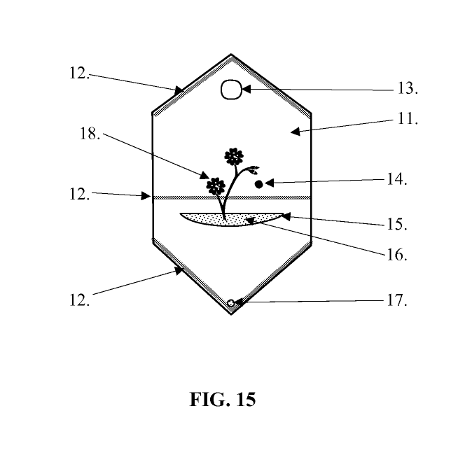

In FIG. 15, tube 11 and seals 12 are reoriented to demonstrate a different aesthetic shape while still maintaining the same fundamental design of this invention.

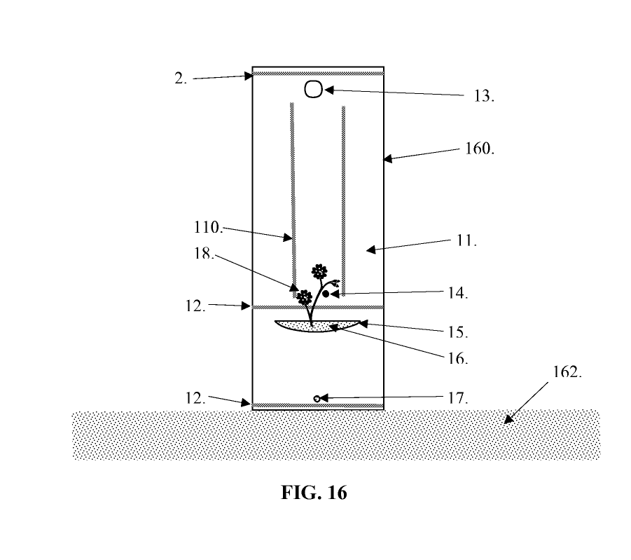

In FIG. 16, the uppermost water bearing chamber 160 is elongated for greater water holding capacity and increased time between watering cycles. In this embodiment, it may be necessary to transfer most of the weight of the water, soil, plant material and device to the ground 162.

Other modifications and implementations will occur to those skilled in the art without departing from the spirit and the scope of the invention as claimed. Accordingly, the above description is not intended to limit the invention except as indicated in the following claims.

What is claimed is:

1. A hanging planter for containing and watering vegetation, the hanging planter comprising:
a lay-flat flexible tube having two walls, the two walls being sealed by a top seal, a middle seal, and a bottom seal so as to form an upper chamber and a lower chamber; and
a hanging element disposed near a top portion of the upper chamber capable of being used to hang the lay-flat flexible tube so that the upper chamber is oriented directly above the lower chamber,
the upper chamber having an opening so as to facilitate filling the upper chamber with water;
the lower chamber having an opening so as to facilitate filling the lower chamber with growing media;
the upper chamber having a flow regulator capable of regulating a flow of water from the upper chamber to the lower chamber;
the lower chamber having a drain capable of draining excess water from the flow of water upon the growing media in the lower chamber.

2. The hanging planter of claim 1, wherein the lay-flat flexible tube is made from one of: plastic, low density polyethylene, flexible PVC.

3. The hanging planter of claim 1, wherein the upper chamber and the lower chamber are equal in volume.

4. The hanging planter of claim 1 wherein the upper chamber and the lower chamber are not equal in volume.

5. The hanging planter of claim 1, wherein the hanging element is a hole cut near the top seal.

6. The hanging planter of claim 1, wherein the hanging element is a rigid member attached near the top seal.

7. The hanging planter of claim 1, wherein the opening in the lower chamber is a horizontal slit cut through at least one wall of the flexible tube near a top portion of the lower chamber.

8. The hanging planter of claim 1, wherein the growing medium is soil.

9. The hanging planter of claim 1, wherein the bottom seal is a recloseable closure.

10. The hanging planter of claim 9, wherein the recloseable closure is mating hook and loop.

11. The hanging planter of claim 9, wherein recloseable closure is double sided tape with acrylic based adhesive.

12. The hanging planter of claim 5, wherein the upper chamber is filled through the hole cut near the top seal.

13. The hanging planter of claim 1, wherein the upper chamber is filled through a recloseable opening therein.

14. The hanging planter of claim 1, wherein a flow of water from the upper chamber into the lower chamber can be regulated by at least one drip emitter placed at least near the bottom of the uppermost chamber.

15. The hanging planter of claim 1, wherein excess water is drained from the lower chamber by a small hole at least near a bottom of the lower chamber.

16. The hanging planter of claim 10 wherein excess water is drained by seeping through the hook and loop reclosure.

17. The hanging planter of claim 1, wherein the opening in the lower chamber for filling the lower chamber with growing media is large enough to also allow planting in the growing media.

18. The hanging planter of claim 9, wherein a pre-started plant can be inserted into the bottom of the lower chamber through the opened recloseable opening, and the reclosable opening can be reclosed so as to secure a root-ball therein.

19. The hanging planter of claim 1, wherein at least one vertical seal is formed longitudinally between the walls of the upper chamber so as strengthen the upper chamber, while also allowing all water in the upper chamber to be flow through the flow regulator.

20. The hanging planter of claim 1, wherein the bottom of the lower chamber is adapted to rest on the ground so as to reduce stress on the hanging element.
